(19) United States
(12) Patent Application Publication
(10) Pub. No.: US 2021/0166701 A1
(43) Pub. Date: Jun. 3, 2021

(54) DEVICE AND METHOD FOR ENCODING / DECODING AUDIO SIGNAL USING FILTER BANK

(71) Applicant: ELECTRONICS AND TELECOMMUNICATIONS RESEARCH INSTITUTE, Daejeon (KR)

(72) Inventors: Woo-taek LIM, Daejeon (KR); Seung Kwon BEACK, Daejeon (KR); Jongmo SUNG, Daejeon (KR); Mi Suk LEE, Daejeon (KR); Tae Jin LEE, Daejeon (KR)

(21) Appl. No.: 17/104,400

(22) Filed: Nov. 25, 2020

(30) Foreign Application Priority Data
Nov. 29, 2019 (KR) 10-2019-0157196

(51) Int. Cl. G10L 19/002

(52) U.S. Cl. CPC G10L 19/002

(57) ABSTRACT

An audio signal encoding/decoding device and method using a filter bank is disclosed. The audio signal encoding method includes generating a plurality of first audio signals by performing filtering on an input audio signal using an analysis filter bank, generating a plurality of second audio signals by performing downsampling on the first audio signals, and outputting a bitstream by encoding and quantizing the second audio signals.

### CROSS-REFERENCE TO RELATED APPLICATION(S)

This application claims the priority benefit of Korean Patent Application No. 10-2019-0157196 filed on Nov. 29, 2019, in the Korean Intellectual Property Office, the disclosure of which is incorporated herein by reference for all purposes.

### BACKGROUND

### 1. Field of the Invention

One or more example embodiments relate to a device and method for encoding and decoding an audio signal, and more particularly, to a device and method for encoding and decoding a waveform-based audio signal using a filter bank.

### 2. Description of Related Art

WaveNet, a deep learning network that generates audio from text, relates to a technology for generating a more natural speech that sounds similar to a human voice, intonation, and the like, compared to existing methods.

Existing text-to-speech (TTS) systems generate a speech by connecting short pronunciations recorded by humans or word-unit audio files. In contrast, a deep learning network model such as WaveNet generates a single audio file corresponding to an entire sentence by applying context-based intonations or pronunciations based on a result of training performed based on massive texts or audio data sets.

However, in WaveNet, to apply a K-fold receptive field, an operation amount or computational amount may increase by a factor of K(K+1)/2, thereby increasing its complexity greatly.

In addition, a waveform-based model such as WaveNet synthesizes or generates a high-quality audio by predicting a subsequent sample using previous samples. Thus, a generation speed may be relatively slow and parallelization may not be readily performed, and it may thus take a great amount of time to generate a sample.

Thus, there is a desire for a method that may simplify the structure of a neural network and enable encoding and decoding in parallel.

### SUMMARY

An aspect provides a device and method for simplifying a structure of a network used to encode and decode an audio signal while maintaining the same receptive field size as an original audio signal.

According to an example embodiment, there is provided an audio signal encoding method including generating a plurality of first audio signals by performing filtering on an input audio signal using an analysis filter bank, generating a plurality of second audio signals by performing downsampling on the first audio signals, respectively, and outputting a bitstream by encoding and quantizing the second audio signals.

The generating of the first audio signals may include generating the first audio signals including different frequency bands of a frequency band of the input audio signal by performing filtering on the input audio signal using a plurality of band-pass filters (BPFs) included in the analysis filter bank and configured to filter different frequency bands.

The generating of the second audio signals may include performing downsampling on the first audio signals proportionally to the number of the BPFs.

The outputting of the bitstream may include encoding the second audio signals using sub-encoders including neural networks respectively corresponding to the second audio signals.

The outputting of the bitstream may include determining a bit allocation per sub-band based on encoded second audio signals obtained through the encoding, and controlling a bit allocation of each of the sub-encoders based on the determined bit allocation.

According to another example embodiment, there is provided an audio signal decoding method including restoring a plurality of second audio signals by inversely quantizing and decoding a received bitstream, restoring a plurality of first audio signals by performing upsampling on restored second audio signals obtained through the restoring, and restoring an input audio signal by performing filtering on restored first audio signals obtained through the restoring using a synthesis filter bank.

The restoring of the second audio signals may include decoding the second audio signals using sub-decoders including neural networks respectively corresponding to the second audio signals.

The restoring of the second audio signals may include determining a bit allocation per sub-band based on decoded second audio signals obtained through the decoding, and controlling a bit allocation of each of the sub-decoders based on the determined bit allocation.

The restoring of the first audio signals may include performing upsampling on the first audio signals proportionally to the number of BPFs included in the synthesis filter bank.

The restoring of the input audio signal may include performing filtering on the first audio signals using BPFs included in the synthesis filter bank and configured to filter different frequency bands, and restoring the input audio signal by synthesizing filtered first audio signals obtained through the filtering.

According to still another example embodiment, there is provided an audio signal encoding device including a filter unit configured to generate a plurality of first audio signals by performing filtering on an input audio signal using an analysis filter bank, a downsampling unit configured to generate a plurality of second audio signals by performing downsampling on the first audio signals, respectively, and an encoding unit configured to output a bitstream by encoding and quantizing the second audio signals.

The filter unit may generate the first audio signals including different frequency bands of a frequency band of the input audio signal by performing filtering on the input audio signal using a plurality of BPFs included in the analysis filter bank and configured to filter different frequency bands.

The encoding unit may encode the second audio signals using sub-encoders including neural networks respectively corresponding to the second audio signals.

The encoding unit may determine a bit allocation per sub-band based on encoded second audio signals obtained through the encoding, and control a bit allocation of each of the sub-encoders based on the determined bit allocation.

According to yet another example embodiment, there is provided an audio signal decoding device including a decoding unit configured to restore a plurality of second audio signals by inversely quantizing and decoding a received bitstream, an upsampling unit configured to restore a plurality of first audio signals by performing upsampling on restored second audio signals obtained through the restoring, and a filtering unit configured to restore an input audio signal by performing filtering on restored first audio signals obtained through the restoring using a synthesis filter bank.

The decoding unit may decode the second audio signals using sub-decoders including neural networks respectively corresponding to the second audio signals.

The upsampling unit may perform upsampling on the first audio signals proportionally to the number of BPFs included in the synthesis filter bank.

The filtering unit may perform filtering on the first audio signals using the BPFs included in the synthesis filter bank and configured to filter different frequency bands, and restore the input audio signal by synthesizing filtered first audio signals obtained through the filtering.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of an audio signal encoding device and an example of an audio signal decoding device according to an example embodiment;

FIG. 2 is a diagram illustrating an example of encoding a waveform-based audio signal according to an example embodiment;

FIG. 3 is a diagram illustrating an example of transmitting an encoded audio signal according to an example embodiment;

FIG. 4 is a diagram illustrating an example of restoring a waveform-based audio signal according to an example embodiment;

FIG. 5 is a flowchart illustrating an example of an audio signal encoding method according to an example embodiment; and

FIG. 6 is a flowchart illustrating an example of an audio signal decoding method according to an example embodiment.

### DETAILED DESCRIPTION

Hereinafter, some examples will be described in detail with reference to the accompanying drawings. However, various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

Hereinafter, example embodiments will be described in detail with reference to the accompanying drawings.

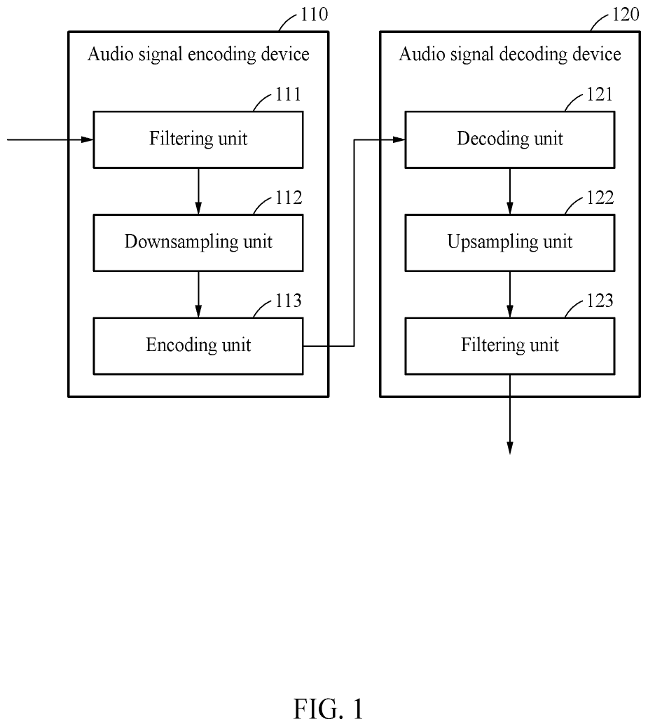

FIG. 1 is a diagram illustrating an example of an audio signal encoding device and an example of an audio signal decoding device according to an example embodiment.

Referring to FIG. 1, an audio signal encoding device 110 includes a filtering unit 111, a downsampling unit 112, and an encoding unit 113. The filtering unit 111, the downsampling unit 112, and the encoding unit 113 may be different processors included in the audio signal encoding device 110, or modules included in a program performed in a single processor.

The filtering unit 111 may generate a plurality of first audio signals by performing filtering on an input audio signal using an analysis filter bank. For example, the filtering unit 111 may generate the first audio signals including different frequency bands of a frequency band of the input audio signal by performing filtering on the input audio signal using a plurality of band-pass filters (BPFs) included in the analysis filter bank and configured to filter different frequency bands.

The downsampling unit 112 may generate a plurality of second audio signals by performing downsampling respectively on the first audio signals generated in the filtering unit 111. For example, the downsampling unit 112 may perform downsampling on the first audio signals proportionally to the number of the BPFs included in the analysis filter bank.

The encoding unit 113 may output a bitstream by encoding and quantizing the second audio signals generated in the downsampling unit 112. For example, the encoding unit 113 may encode the second audio signals using sub-encoders including neural networks respectively corresponding to the second audio signals. In this example, the encoding unit 113 may determine a bit allocation per sub-band based on encoded second audio signals obtained through the encoding, and control a bit allocation of each of the sub-encoders based on the determined bit allocation.

Referring to FIG. 1, an audio signal decoding device 120 includes a decoding unit 121, an upsampling unit 122, and a filtering unit 123. The decoding unit 121, the upsampling unit 122, and the filtering unit 123 may be different processors included in the audio signal decoding device 120, or modules included in a program performed in a single processor.

The decoding unit 121 may restore a plurality of second audio signals by inversely quantizing and decoding a bitstream received from the audio signal encoding device 110. For example, the decoding unit 121 may decode the second audio signals using sub-decoders including neural networks respectively corresponding to the second audio signals. In this example, the decoding unit 121 may determine a bit allocation per sub-band based on decoded second audio signals obtained through the decoding, and control a bit allocation of each of the sub-decoders based on the determined bit allocation.

The upsampling unit 122 may restore a plurality of first audio signals by performing upsampling on the second audio signals restored by the decoding unit 121. For example, the upsampling unit 122 may perform upsampling on the first audio signals proportionally to the number of BPFs included in a synthesis filter bank.

The filtering unit 123 may restore an input audio signal by performing filtering on the first audio signals restored by the upsampling unit 122 using the synthesis filter bank. For example, the filtering unit 123 may perform filtering on the first audio signals using a plurality of BPFs included in the synthesis filter bank and configured to filter different frequency bands, and restore the input audio signal by synthesizing filtered first audio signals obtained through the filtering.

The audio signal encoding device 110 and the audio signal decoding device 120 may reduce a dimension of an audio signal using a filter bank in a waveform-based audio coding neural network. Thus, it is possible to simplify a network structure used to encode and decode an audio signal while maintaining the same receptive field size as an original audio signal. In addition, by simplifying the network structure, it is possible to improve an audio signal encoding speed and an audio signal decoding speed.

Further, the audio signal encoding device 110 and the audio signal decoding device 120 may enable parallelized model training and audio signal generation, and obtain a restored audio quality improved within a limited bit rate by adjusting a bit allocation per sub-band.

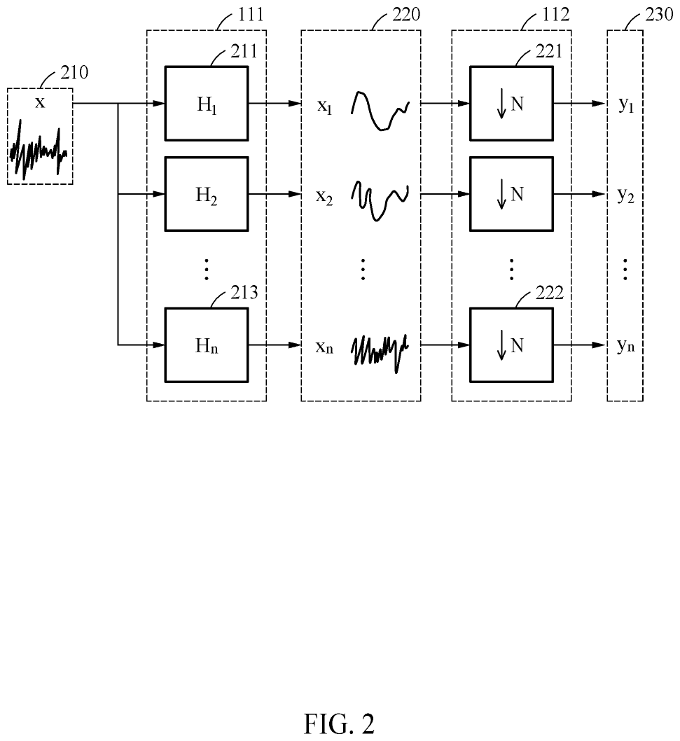

FIG. 2 is a diagram illustrating an example of encoding a waveform-based audio signal according to an example embodiment.

Referring to FIG. 2, the filtering unit 111 may generate n first audio signals x₁ through xₙ 220 by performing filtering on an input audio signal x 210 using a filter bank. For example, filters H₁ through Hₙ included in the filter bank may have the same frequency magnitude or different frequency magnitudes.

The first audio signals 220 may be signals obtained by dividing the input audio signal x 210 by n, and have 1/n samples based on the input audio signal x 210. Thus, there may be no aliasing occurring despite n-fold downsampling of the first audio signals 220.

The downsampling unit 112 may generate n second audio signals y₁ through yₙ 230 by performing the n-fold downsampling on the first audio signals 220.

After divided by the filtering unit 111 and then downsampled by the downsampling unit 112, the second audio signals 230 may have a data form of a lower dimension compared to the input audio signal x 210. Thus, a structure of a waveform-based encoder neural network to be used by the encoding unit 113 to encode the second audio signals 230 may be simplified. In addition, the second audio signals 230 may be signals downsampled from the input audio signal x 210, and thus a receptive field may be maintained the same as the input audio signal x 210.

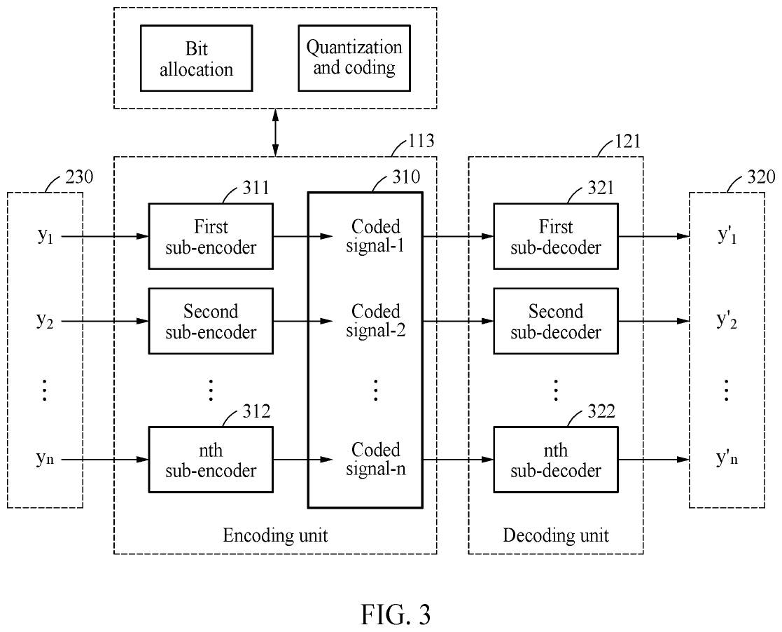

FIG. 3 is a diagram illustrating an example of transmitting an encoded audio signal according to an example embodiment.

Referring to FIG. 3, the encoding unit 113 of the audio signal encoding device 110 includes n sub-modularized sub-encoders 311 and 312. Each of the sub-encoders 311 and 312 may include a neural network to encode the second audio signals 230. In addition, the neural network of each of the sub-encoders 311 and 312 may be trained through neural networks of a same structure or different structures.

A bit allocation unit and a quantization and coding unit of the encoding unit 113 may control a bit allocation per sub-band encoder, and thus adaptively control a bit allocation that may occur in a process of quantizing the second audio signals 230. For example, the bit allocation unit and the quantization and coding unit may allocate a bit amount per code signal based on an encoded signal obtained through each of the sub-encoders 311 and 312.

A bit amount per sub-band may be important to determine an audio signal restoration quality and efficiency, and it may thus be required to allocate an optimal bit within a limited bit amount. Thus, the bit allocation unit and the quantization and coding unit may calculate a bit amount and a restoration quality that may minimize a loss in a process of quantization and restoration using a less bit, and set a bit amount to be allocated to the sub-encoders 311 and 312 based on a result of the calculating. For example, a method of calculating the bit amount to be allocated to the sub-encoders 311 and 312 may be determined based on a neural network for a bit allocation, an order of a filter bank or a band size, an entropy, a psychoacoustic model, and the like.

A bitstream 310 output by encoding and quantizing the second audio signals 230 by the encoding unit 113 may include coded signals.

Referring to FIG. 3, the decoding unit 121 of the audio signal decoding device 120 includes n sub-modularized sub-decoders 321 and 322. The decoding unit 121 may restore second audio signals 320 by inversely quantizing and decoding the coded signals in the bitstream 310 using then sub-decoders 321 and 322, respectively.

Each of the sub-decoders 321 and 322 may include a neural network for decoding the second audio signals 320. In addition, the neural network of each of the sub-decoders 321 and 322 may be trained through neural networks of a same structure or different structures.

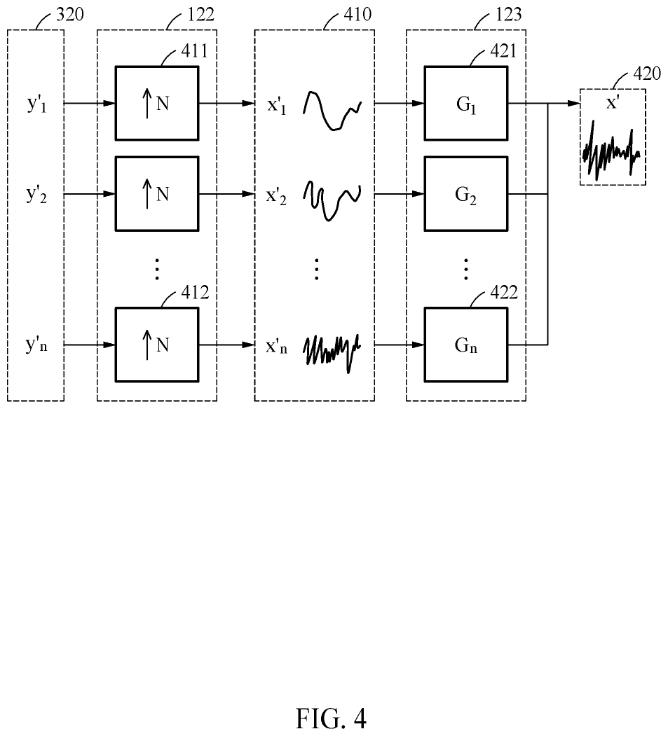

FIG. 4 is a diagram illustrating an example of restoring a waveform-based audio signal according to an example embodiment.

Referring to FIG. 4, the upsampling unit 122 may restore first audio signals 410 by performing n-fold upsampling on the second audio signals 320 restored by the decoding unit 121.

The filtering unit 123 may restore an input audio signal 420 by performing filtering on the first audio signals 410 using a synthesis filter bank. The synthesis filter bank may perform filtering on the first audio signals 410 using BPFs G₁ through Gₙ, and restore the input audio signal 420 by synthesizing first audio signals obtained through the filtering.

The upsampling unit 122 and the filtering unit 123 may perform a process of restoring an audio signal for each sub-band of the audio signal as illustrated in FIG. 4, and it is thus possible to greatly reduce decoding complexity and perform decoding in parallel.

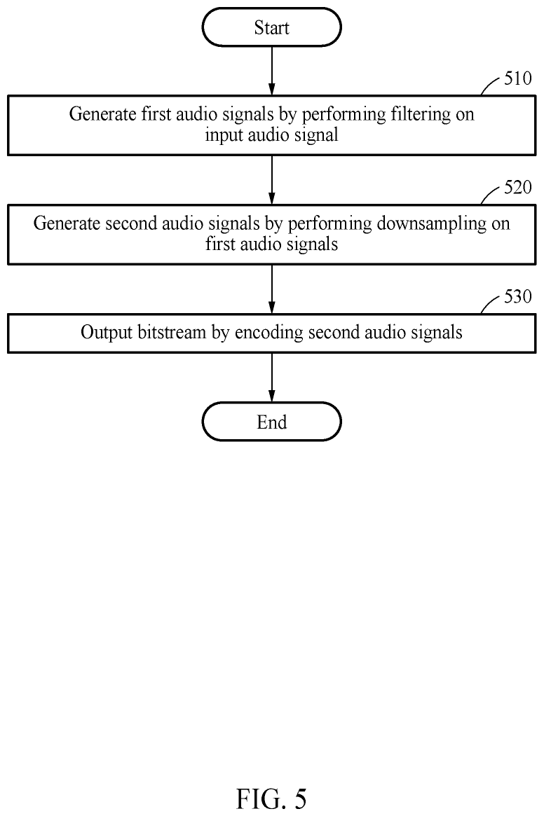

FIG. 5 is a flowchart illustrating an example of an audio signal encoding method according to an example embodiment.

Referring to FIG. 5, in operation 510, the filtering unit 111 generates a plurality of first audio signals by performing filtering on an input audio signal using an analysis filter bank. For example, the filtering unit 111 may perform filtering on the input audio signal using a plurality of BPFs included in the analysis filter bank and configured to filter different frequency bands, and generate the first audio signals including different frequency bands of a frequency band of the input audio signal.

In operation 520, the downsampling unit 112 generates a plurality of second audio signals by performing downsampling on the first audio signals generated in operation 510. For example, the downsampling unit 112 may perform downsampling on the first audio signals proportionally to the number of the BPFs included in the analysis filter bank.

In operation 530, the encoding unit 113 outputs a bitstream by encoding and quantizing the second audio signals generated in operation 520. For example, the encoding unit 113 may encode the second audio signals using sub-encoders including neural networks respectively corresponding to the second audio signals.

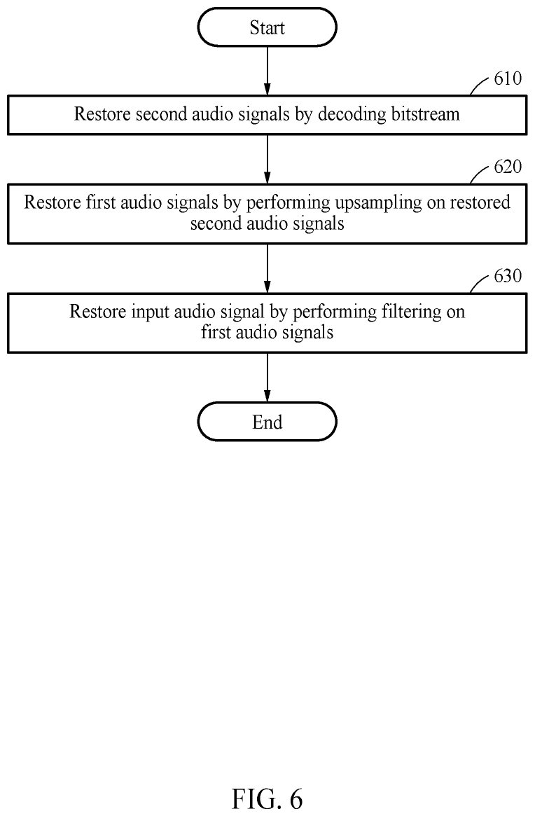

FIG. 6 is a flowchart illustrating an example of an audio signal decoding method according to an example embodiment.

Referring to FIG. 6, in operation 610, the decoding unit 121 restores a plurality of second audio signals by inversely quantizing and decoding a bitstream received from the audio signal encoding device 110. For example, the decoding unit 121 may decode the second audio signals using sub-decoders including neural networks respectively corresponding to the second audio signals.

In operation 620, the upsampling unit 122 restores a plurality of first audio signals by performing upsampling on the second audio signals restored in operation 610. For example, the upsampling unit 122 may perform upsampling on the first audio signals proportionally to the number of BPFs included in a synthesis filter bank.

In operation 630, the filtering unit 123 restores an input audio signal by performing filtering on the first audio signals restored by the upsampling unit 122 in operation 620 using the synthesis filter bank. For example, the filtering unit 123 may perform filtering on the first audio signals using the BPFs included in the synthesis filter bank and configured to filter different frequency bands, and restore the input audio signal by synthesizing filtered first audio signals obtained through the filtering.

According to example embodiments described herein, in a waveform-based audio coding neural network, by reducing a dimension of an audio signal using a filter bank, it is possible to simplify a network structure to be used for encoding and decoding an audio signal while maintaining the same receptive field size as an original audio signal.

According to example embodiments described herein, by simplifying a network structure to be used for encoding and decoding an audio signal, it is possible to improve an audio signal encoding and decoding speed.

An audio signal encoding device and an audio signal decoding device, or an audio signal encoding method and an audio signal decoding method may be written in a program implementable in a computer, and implemented by various recording media, such as, for example, a magnetic storage medium, an optical reading medium, a digital storage medium, and the like.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An audio signal encoding method comprising:
generating a plurality of first audio signals by performing filtering on an input audio signal using an analysis filter bank;
generating a plurality of second audio signals by performing downsampling on the first audio signals, respectively; and
outputting a bitstream by encoding and quantizing the second audio signals.

2. The audio signal encoding method of claim 1, wherein the generating of the first audio signals comprises:
generating the first audio signals including different frequency bands of a frequency band of the input audio signal by performing filtering on the input audio signal using a plurality of band-pass filters (BPFs) included in the analysis filter bank and configured to filter different frequency bands.

3. The audio signal encoding method of claim 2, wherein the generating of the second audio signals comprises:
performing downsampling on the first audio signals proportionally to the number of the BPFs.

4. The audio signal encoding method of claim 1, wherein the outputting of the bitstream comprises:
encoding the second audio signals using sub-encoders including neural networks respectively corresponding to the second audio signals.

5. The audio signal encoding method of claim 4, wherein the outputting of the bitstream comprises:
determining a bit allocation per sub-band based on encoded second audio signals obtained through the encoding; and
controlling a bit allocation of each of the sub-encoders based on the determined bit allocation.

6. An audio signal decoding method comprising:
restoring a plurality of second audio signals by inversely quantizing and decoding a received bitstream;
restoring a plurality of first audio signals by performing upsampling on restored second audio signals obtained through the restoring; and
restoring an input audio signal by performing filtering on restored first audio signals obtained through the restoring using a synthesis filter bank.

7. The audio signal decoding method of claim 6, wherein the restoring of the second audio signals comprises:
decoding the second audio signals using sub-decoders including neural networks respectively corresponding to the second audio signals.

8. The audio signal decoding method of claim 7, wherein the restoring of the second audio signals comprises:
determining a bit allocation per sub-band based on decoded second audio signals obtained through the decoding; and
controlling a bit allocation of each of the sub-decoders based on the determined bit allocation.

9. The audio signal decoding method of claim 6, wherein the restoring of the first audio signals comprises:
performing upsampling on the first audio signals proportionally to the number of band-pass filters (BPFs) included in the synthesis filter bank.

10. The audio signal decoding method of claim 6, wherein the restoring of the input audio signal comprises:
performing filtering on the first audio signals using BPFs included in the synthesis filter bank and configured to filter different frequency bands; and
restoring the input audio signal by synthesizing filtered first audio signals obtained through the filtering.

11. A non-transitory computer-readable storage medium storing instructions that, when executed by a processor, cause the processor to perform the method of claim 1.

12. An audio signal encoding device comprising:
a filter unit configured to generate a plurality of first audio signals by performing filtering on an input audio signal using an analysis filter bank;
a downsampling unit configured to generate a plurality of second audio signals by performing downsampling on the first audio signals, respectively; and
an encoding unit configured to output a bitstream by encoding and quantizing the second audio signals.

13. The audio signal encoding device of claim 12, wherein the filter unit is configured to:
generate the first audio signals including different frequency bands of a frequency band of the input audio signal by performing filtering on the input audio signal using a plurality of band-pass filters (BPFs) included in the analysis filter bank and configured to filter different frequency bands.

14. The audio signal encoding device of claim 12, wherein the encoding unit is configured to:
encode the second audio signals using sub-encoders including neural networks respectively corresponding to the second audio signals.

15. The audio signal encoding device of claim 14, wherein the encoding unit is configured to:
determine a bit allocation per sub-band based on encoded second audio signals obtained through the encoding; and
control a bit allocation of each of the sub-encoders based on the determined bit allocation.
